(19) United States
(12) Patent Application Publication
(10) Pub. No.: US 2009/0015411 A1
(43) Pub. Date: Jan. 15, 2009

(54) MEDICAL PRODUCTS

(75) Inventor: Jianquan Li, Shenzhen City (CN)

Correspondence Address: James B. Conte;Welsh & Katz, Ltd., 22nd Floor, 120 South Riverside Plaza, Chicago, IL, 60606-3912, US

(73) Assignee: Winner Industries (Shenzhen) Co., Ltd.

(21) Appl. No.: 12/170,325

(22) Filed: Jul. 9, 2008

(30) Foreign Application Priority Data
Jul. 10, 2007 (CN) 200710129414.4

(51) Int. Cl. G08B 13/14

(52) U.S. Cl. 340/572.1

(57) ABSTRACT

Disclosed are a medical product and a system for wirelessly identifying a location of the medical product. In an implementation, the medical product has a body like a conventional surgical drape and a module attached to the body. The module is wirelessly communicated with a detector which shows a location of the medical product.

### CROSS REFERENCE TO RELATED APPLICATIONS

This application claims the benefit of Chinese Patent Application No. 200710129414.4 filed Jul. 10, 2007 which is incorporated herein by reference in its entirety.

### TECHNICAL FIELD

This invention is directed to medical products and particularly to surgical products that can be wirelessly detected.

### BACKGROUND OF THE INVENTION

Surgical products like medical dressings, abdominal pads, drapes, gauzes and pledgets have been used for hemostasis and clearing blood or a body fluid in operation. However, the surgical products like surgical pads and gauzes dipped with blood or a body fluid frequently have been found being left in the patient's body during operation due to the negligence of the medical personnel.

X-ray has generally been used to detect whether such a product is unintentionally left in the patient or where it stays. In this case, a substance detectable by X-ray is often added to the medical product so that it can be detected by X-ray. However, the X-ray detection only can be generally performed with a special facility after the operation. Moreover, X-ray is radioactive and harmful to the patient.

### SUMMARY OF THE INVENTION

To address the above problem, there is provided a medical product used in a surgical operation comprising: a body; and a module attached to the body that can be wirelessly detected.

The present invention also provides a system for identifying a location of a medical product comprising a body and a module attached to the body, comprising a detector that can wirelessly communicate with the module to locate the location of the medical product.

When an operation is finished, the medical personnel may use the detector, before suturing a wound on the patient, to confirm whether a medical product is left in the patient's body so as to avoid malpractices.

Other aspects, features and advantages will be apparent from the following detailed description, the drawings and the claims.

### BRIEF DESCRIPTION OF THE DRAWING

FIG. 1 is a schematic diagram illustrating a medical product having a wirelessly detectable module according to an embodiment of the present invention;

FIG. 2 is a schematic diagram illustrating an example of an RFID module and a detector;

FIG. 3 is a schematic diagram illustrating an example of a non-contact IC module and a detector; and

FIG. 4 is a schematic diagram illustrating a bar code and a detector with a reading device.

### DETAILED DESCRIPTION OF THE INVENTION

Hereinafter, a detailed description of the present invention will be given with reference to the appended drawings and embodiments.

The term “a conventional medical product” or “conventional medical products” as referred to herein may be a medical product that is used in operation but can be unintentionally left in a patient's body due to the negligence of the medical personnel, for example, medical dressings, abdominal pads, drapes, gauzes and pledgets.

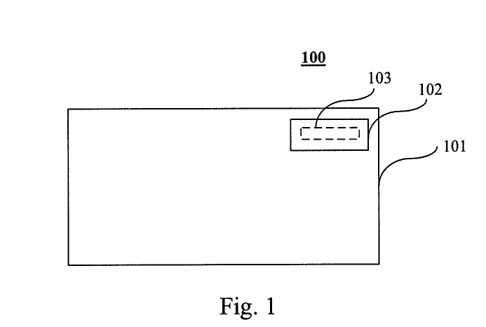

Referring to FIG. 1, it shows a medical product 100 according to the present invention. A body 101 that can be one of the conventional medical products in the art, and a module 103 attached to the body 101 are provided.

The body 101 herein referred to correspond to “a conventional medial product” as referred to hereinabove. The module 103 should be wirelessly detectable, of which examples may include an RFID module, a non-contact IC module or a bar code. The module 103 should be prepared to provide an isolation outer surface so that blood or other body fluids have no impact on the working of the module.

In some embodiments, the medical product can further comprise a casing 102 enclosing the module 103. The casing 102 can be made of a nontoxic isolation material such as rubber and plastic.

The module 103 or the casing 102 can be attached to an outer surface of the body 101 or embodied within the body by a process known well in the art for example, by sewing, adhering, fusing or weaving.

In an implementation, the medical product has a body made of a spunlaced non-woven fabric. In the preparation, a plurality of modules 103 or casings 102 each enclosing a module are regularly adhered to a large spunlaced non-woven fabric. Subsequently, the spunlaced non-woven fabric is cut, folded and then sewed to form a plurality of surgical pads each having one module 103 or one casing 102.

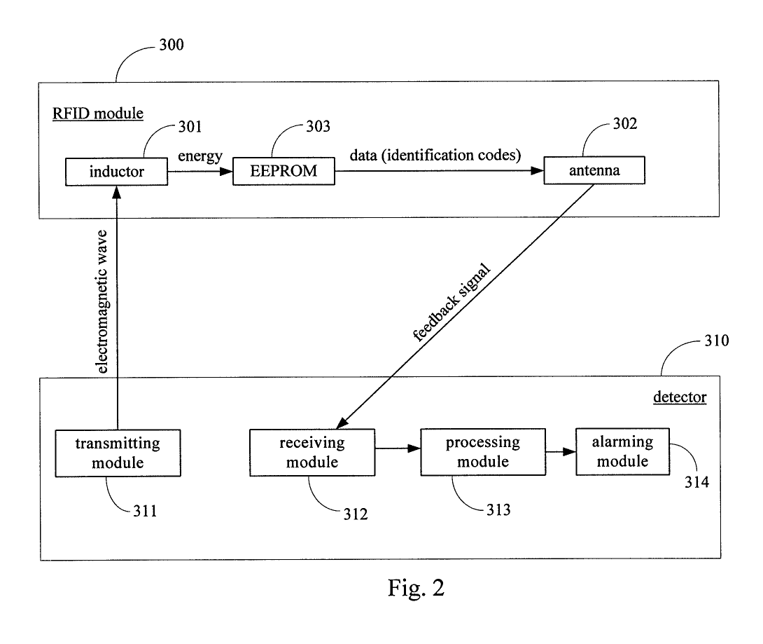

In one of embodiments, the module 103 is a Radio Frequency Identification (RFID) module. As shown in FIG. 2, the RFID module 300 has an inductor 301, an antenna 302 and an EEPROM 303 for storing identification codes and other data. To avoid a large volume, the RFID module 300 is passive. The required energy in use is generated by inductive coupling from the electromagnetic wave transmitted by a detector 310. The capability of the EEPROM 303 may be in a range from several bits and tens of kilobits. The identification codes stored in the EEPROM 303 may be transmitted through the antenna 302 by using the energy obtained from an induced current. The RFID module 300 has the advantages of light weight, small volume, long life and low cost.

The detector 310 is provided with a transmitting module 311, a receiving module 312, a processing module 313 and an alarming module 314, as shown in FIG. 2. In this embodiment, the alarming module 314 may be selected from the group consisting of a lighting module, a vibrating module, a sounding module and a combination thereof, which can be used to give warning by lighting, vibrating and sounding, respectively.

During operation, before a wound on the patient is to be sutured, the transmitting module 311 of the detector 310 moved near the patient is controlled to transmit an electromagnetic wave. If a medical product having at least one RFID module 300 is left in the patient's body, the inductor 301 in the RFID module 300 will, responding to the electromagnetic wave, generate an induced current by coupling. Then, the RFID module 300 transmits the identification codes stored in the EEPROM 303 in the form of an electromagnetic wave (i.e. a feedback signal) which can be received by the receiving module 312. If the processing module 313 judges that the frequency of the electromagnetic wave and the identification codes are suitable, it controls the alarming module 314 to give warning.

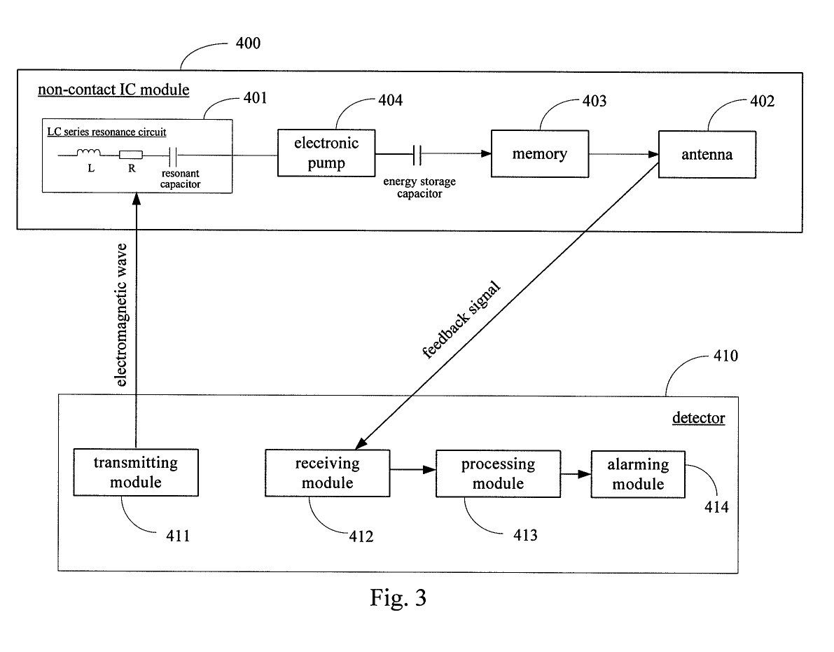

In another embodiment, the module 103 is a non-contact IC module comprising an LC series resonance circuit whose frequency is equal to the transmitting frequency of the transmitting module of the detector. FIG. 3 shows an example of the non-contact IC module 400 and a detector. In this embodiment, the detector 410 can be configured as the same as the detector 310 in the above embodiment, which will not be described in detail hereinafter. As shown in FIG. 3, a resonant capacitor in the LC series resonance circuit 401 is connected to one terminal of a unilateral electronic pump 404 (e.g. a diode), the other terminal of which is connected with an energy storage capacitor. During detection, if a medical product having at least one non-contact IC module 400 is left in the patient's body, the LC resonance circuit 401 is excited by a set of electromagnetic waves with constant frequencies transmitted by the detector 410 to generate resonance. Subsequently, charges are generated in the resonant capacitor and transported to the energy storage capacitor through the electronic pump 404. When the charges in the energy storage capacitor are accumulated up to a certain amount, for example, the accumulated charges reaching a voltage of 2V, the energy storage capacitor may act as a source for transmitting the data stored in the memory 403 via the antenna 402 so as to transmit a feedback signal to the detector 410. The subsequent steps are similar to those of the above embodiment and therefore will not be described herein.

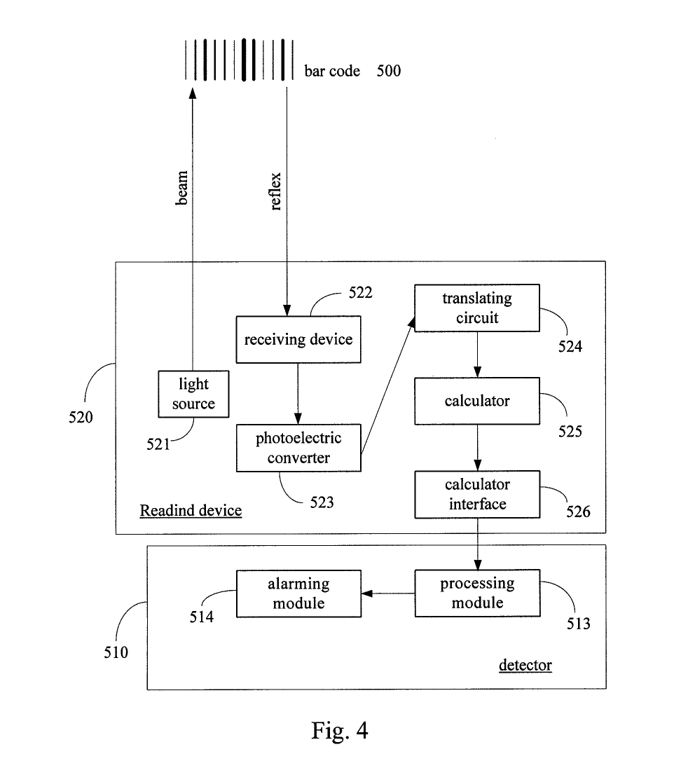

In still another embodiment, the wireless identification module is a bar code having a set of bar symbols arranged by a certain coding rule for representing the information of characters, numbers or symbols. FIG. 4 shows an example of the embodiment. According to this embodiment, the medical product is provided with a bar code 500 which can be detected by using a detector 510 and a reading device 520 for bar codes. The reading device 520 comprises a light source 521, a receiving device 522, a photoelectric converter 523, a translating circuit 524, a calculator 525 and a calculator interface 526 connected with a processing module 513 of the detector 510. During an operation in hospital, the reading device 520 is used to scan the patient's body. If a medical product having at least one bar code 500 is left in the patient's body, the bar code is irradiated by a beam transmitted by the light source 521 and passing through an optical system (not shown). Then, a reflex from the bar code passes back through the receiving device 522 and is imaged on the photoelectric converter 523 to generate an electric signal. The electric signal is amplified to generate an analog signal which is proportional to the reflex. Subsequently, the analog signal is filtered and shaped to form a corresponding square-wave signal. Then, the square-wave signal is translated to a calculator-acceptable digital signal by the translating circuit 524. The calculator 525 then transmits a control signal to the processing module 513 of the detector 510 through the calculator interface 526. The subsequent steps are similar to those of the above embodiments and therefore will not be described herein.

The present invention is not limited to the description or embodiments mentioned above. Other implementations are within the scope of the following claims.

1. A medical product used in a surgical operation comprising:
a body; and
a module attached to the body that can be wirelessly detected.

2. The medical product of claim 1, further comprising
a casing enclosing the module, wherein the casing is embodied within the body or attached to a surface of the body.

3. The medical product of claim 2, wherein the casing is made of a nontoxic isolation material such as rubber or plastic.

4. The medical product of claim 1, wherein the module is an RFID module, a non-contact IC module or a bar code.

5. The medical product of claim 1, wherein the body is an abdominal pad, a medical dressing or a surgical drape.

6. A system for identifying a location of a medical product comprising a body and a first module attached to the body, comprising
a detector that can wirelessly communicate with the first module to locate the location of the medical product.

7. The system of claim 6, wherein the medical product further comprises:
a casing enclosing the first module, wherein the casing is embodied within the body or attached to a surface of the body.

8. The system of claim 7, wherein the casing is made of a nontoxic material such as rubber or plastic.

9. The system of claim 6, wherein the first module is an RFID module, a non-contact IC module or a bar code.

10. The system of claim 6, wherein the body is an abdominal pad, a medical dressing or a surgical drape.

11. The system of claim 6, wherein the detector comprises:
a module for transmitting an electromagnetic wave which can reach the first module;
a module for receiving a signal transmitted by the first module in response to the electromagnetic wave;
a module for processing the signal; and
a module for alarming controlled by the module for processing.
